(19) United States
(12) Patent Application Publication
(10) Pub. No.: US 2007/0271782 A1
(43) Pub. Date: Nov. 29, 2007

(54) Electrical Multilayer Component with Solder Contact

(76) Inventors: Christian Block, Stainz (AT); Sebastian Brunner, Graz (AT); Thomas Feichtinger, Graz (AT); Gunter Pudmich, Koflach (AT)

Correspondence Address: FISH & RICHARDSON PC, P.O. BOX 1022, MINNEAPOLIS, MN, 55440-1022, US

(21) Appl. No.: 11/630,524

(22) PCT Filed: Jun. 30, 2005
(86) PCT No.: PCT/DE05/01155

§ 371 Date: Feb. 8, 2007

(30) Foreign Application Priority Data
Jul. 1, 2004 (DE) 10 2004 031 878.6

(51) Int. Cl. H01R 9/00

(52) U.S. Cl. 29/843; 310/358; 29/25.03; 29/852

(57) ABSTRACT

An electrical multilayer component includes a base body having stacked ceramic dielectric and metallization layers that are formed into component structures among the dielectric layers. Solder contacts are on the underside of the base body. Plated through-holes connect the component structures to the solder contacts. The plated through-holes have at least cross section that widens upward away from the solder contact.

### TECHNICAL FIELD

This patent application describes an electrical multilayer component, the base body of which is constructed of dielectric layers. Metallization planes formed as structures for components are among the dielectric layers. Depending on the nature of the dielectric layers and the electrode layers, such multilayer components can be used as, for instance, as capacitors, varistors or temperature-dependent resistors (thermistors).

### BACKGROUND

A multilayer varistor, in which non-overlapping internal electrodes are arranged in the interior of its base body in order to reduce the resistance, is known from the publication DE 199 31 056 A1. The internal electrodes in this case are contacted on two end faces of the component by large-surface contact layers that permit SMD manufacture of the component. The disadvantage of such a conventional component is that, due to the large-surface contact layers, parasitic capacitances and inductances build up that make precise adjustment of the electrical characteristics of the component difficult. Moreover, such a component requires a great deal of space on, for instance, circuit boards because of the large contact layers. Above all, modules in which several of these components are integrated are particularly large in this type of construction, and therefore have an especially low integration density.

Also known are multilayer components that are held on a PCB circuit board by flip-chip mounting. For this purpose, they have solderable contacts on their underside, which allow them to be soldered onto the PCB circuit board by bumps. Since such a component is usually mounted via a plurality of bumps, and the material of the multilayer component differs from that of the PCB. It is possible for large mechanical strains, which stress the soldering points and especially on the metallizations connected thereto, to appear, particularly in case of temperature changes. Therefore, bumps can detach from the solder contacts, the solder contacts can detach from the multilayer component, or the plated through-holes connected to the solder contacts and creating the connection to the internal component structures can be pulled out of the lowest dielectric layer by the bumps.

### SUMMARY

Described herein is an electrical multilayer component with a ceramic base body that has a stable and stress-free solder contact.

As described herein, in the base body of the multilayer component, at least the plated through-holes that are connected to the solder contacts placed on the underside of the base body be designed such that, at least in some sections, their cross section expands upwards, i.e., facing away from the solder contact. In this way, a plated through-hole and a solder contact that can be connected thereto are obtained which have a secure seating in the base body. The plated through-hole, which includes an appropriate borehole in the dielectric layer and the metallization arranged therein, is protected in this manner from being pulled out of the base body. Thereby, detachment of the contact by forces that act on the solder contact after it is soldered to, for instance, a circuit board becomes more difficult.

The base body itself comprises several ceramic dielectric layers stacked one on top of the other, with metallization structured into component structures among them. Internal electrical connection between different metallization planes, as well as between the component structures and the solder contacts is accomplished by way of plated through-holes, each of which can extend through one or more of the dielectric layers. All plated through-holes in the component, but at least those that are connected to the solder contacts on the underside of the base body, can be constructed in the manner described herein.

Additionally, the dielectric layers can advantageously comprise an electroceramic. The ceramic material can thus comprise a varistor ceramic based on ZnO—Bi or ZnO—Pr. The ceramic material can further comprise a capacitor ceramic that is selected from the so-called NPO ceramics, e.g., (Sm,Pa)NiCdO₃. These ceramics have temperature-dependent ∈ᵣ values, and are non-ferroelectric ceramics. Additionally, it is also possible to use ferroelectric ceramics with high dielectric constants, such as doped BaTiO₃ and so-called barrier-layer ceramics. These dielectric ceramics are described in the book “Keramik” [Ceramics], H. Schaumburg (ed.), B. G. Teubner-Verlag, Stuttgart, 1994, on pages 351-352 and 363, the entire content of these pages being incorporated herein by reference. The ceramic material can additionally be selected from thermistor ceramics or NTC ceramics, e.g., nickel manganese spinels and perovskites. Dielectric nonceramic materials such as glasses, can also be used.

Furthermore, all dielectric layers in the component are advantageously either a varistor, thermistor or capacitor ceramic, so that there are no dielectric layers in the base body that do not have one of these electrical properties.

In one configuration, the cross section of the plated through-holes is smallest in a central section and slightly widens upwards and downwards from this middle section, “downwards” meaning in the direction towards the underside of the component, and “upwards” in the opposite direction.

This embodiment is distinguished in that, in the area of the plated through-hole, a maximal contact interface with the dielectric layer or layers is available through which the plated through-hole passes. At the same time, such a plated through-hole has a maximal contact interface with both the solder contact and with the component structure that is connected to the solder contact via the plated through-hole. This provides a particularly good seating of the plated through-hole and thus a particularly good support of the solder contacts and hence a high degree of stability of the component.

In one embodiment, the plated through-holes are formed with a cross section that is concave at the sides. In this case the central section with the smallest diameter or smallest cross-sectional area can be obtained by rounding off the edges of the dielectric layer/dielectric layers bounding the plated through-hole.

In another embodiment, the plated through-holes are formed such that they have a cross section that corresponds to a double cone in which the two vertices collide with or penetrate one another.

The solder contacts are provided at least in the surface area that corresponds to the cross-sectional surface at the underside of the base body of the plated through-hole leading thereto. In case of highly miniaturized components for small base bodies and small diameters of the plated through-holes, this surface alone can be sufficient for producing a solder contact. The surface is also sufficient if the diameters of the bumps that are connected to the solder contact are approximately equal to the diameters of the respective plated through-holes at the underside. This particularly concerns components in which a plurality of bumps are required to produce the necessary electrical connections of the component, the diameter of the bumps lying in the range of 30-100 μm.

In the other cases and for larger bumps, the solder contact requires a larger surface and is placed on the underside of the base body such that it partially overlaps the lowermost dielectric layer or lies on the latter. In such a case, it is advantageous to provide the sublayer of the solder contact directly contacting the ceramic dielectric layer with a glass component, which ensures better adhesion on the ceramic dielectric layer. Alongside the glass component, this layer then comprises at least one metal or a metal alloy. Such a type of solder alloy may be applied in the form of a printable paste and is, for instance fired on.

In one configuration, the solder contacts comprise a layer whose material is selected from tin (Sn), tin-lead alloy (SnPb), tin-silver-copper alloy (SnAgCu), tin-silver-copper-bismuth alloy (SnAgCuBi), tin-zinc alloy (SnZn) and tin-silver alloy (SnAg). The solder contact can also comprise additional layers that are selected from this spectrum.

A diffusion-blocking layer is also advantageously provided in the solder contact. During positioning or soldering of the bumps onto the solder contact, this prevents an alloy formation with components of the metallization inside the plated through-hole, which would impermissibly change the properties of the latter or even result in the cut-off of the electrical connection. This is an advantage particularly in the use of lead-free solders, since the material of these solders has a particular tendency to alloy with the silver or palladium that may be used in the plated through-holes.

The diffusion-blocking layer for preventing alloy formation may be selected from nickel, tin and gold. The diffusion-blocking layer can be arranged close to the plated through-hole or also in a layer region of the solder contact that is further away from the plated through-hole. For solder contacts whose surface area is limited to the opening of the plated through-hole, the solder contact can include solely the diffusion-blocking layer, formed in that case directly and only on the plated through-hole.

As the outermost layer, the solder contact advantageously has an antioxidation layer which can prevent, for instance, the oxidation of the layer of the solder contact directly below it, such as a nickel layer used as a diffusion-blocking layer. Such an antioxidation layer can be chosen, for example, from gold, tin, and an organic layer. While an antioxidation layer comprising gold provides long-term protection for the solder contact, the tin layer can also be alloyed during soldering, which is not deleterious, however. The organic oxidation layer, on the other hand, is oxidatively destroyed or vaporized during the soldering process. An antioxidation layer is no longer necessary after soldering, since an oxidation could take place at most only on the surface and can no longer interrupt the current path or no longer leader lead to a substantial increase of the corresponding resistance. Any impaired solderability caused thereby is insignificant as well.

In another configuration, a passivation for the ceramic dielectric layers is provided on the base body. For instance, glass surfaces having good adhesion, mechanical stability and the necessary moisture-tightness, and thus also a sufficient protection for the ceramic, particularly from attack by acidic or basic deposition baths, are suitable for this purpose. For electrically conductive ceramics such as varistor ceramics, the passivation is required as electrical insulation if a galvanic process is used for producing the solder contacts. If lower requirements are placed on the passivation, it is also possible to use other types of layers, for instance, organic ones, as passivation. The passivation can be vapor-deposited, printed, sputtered, spun on, dropped on or applied in some other way.

Since the solder contact must remain free of the passivation, it is produced after the passivation. In order to contact the solder contacts to be produced on the passivation electrically with the respective plated through-holes, openings are left in the passivation, or are subsequently created. In order to create a sufficient tolerance in the manufacturing of these openings, a contact surface having a sufficient surface area is produced above the plated through-holes before passivation. The openings in the passivation, through which the solder contact then has contact with the contact surface and thus with the plated through-hole, can be arranged over an arbitrary surface area of the contact surface. It is therefore not necessary to arrange the openings with high precision directly over the plated through-holes, which increases process security.

The metallization for the plated through-holes in a multilayer component can be selected from silver (Ag), palladium (Pd), platinum (Pt), silver-palladium (AgPd), silver-platinum (AgPt), silver-palladium-platinum (AgPdPt), nickel (Ni), copper (Cu) or gold (Au). These materials can be placed in the corresponding openings/boreholes for the plated through-holes already at the stage of the green films and sintered together with the latter.

Selection of the corresponding materials for the plated through-holes is dependent on the ceramic material, and particularly on the sintering temperatures necessary for the ceramic material. For low-sintering ceramics, the plated through-holes can be produced from silver. Higher-sintering ceramics such as HTCC ceramics require more temperature-resistant materials, in particular, platinum.

The solder contact lying on the underside of the base body can have an adhesion promotion layer selected from nickel, copper, chromium or silver, as a lowermost layer in direct contact with the ceramic dielectric layer. These materials show particularly good adhesion to the ceramic and therefore increase the adhesion of the entire solder contact during the operation as well.

A component may be designed for various purposes, and is defined by selection of the ceramic and by the structuring of the corresponding metallization planes. The component can be formed as a multilayer varistor, as a ceramic multilayer capacitor, as multilayer thermistor or as a multilayer component comprising a ferrite ceramic.

A ceramic multilayer capacitor is distinguished by a dielectric with high dielectric constant and multilayer electrode structures created in the metallization planes, wherein two type of overlapping electrodes are arranged one above the another such that a desired and, in particular, a maximal overlap surface between the two types of electrodes results. In addition to the dielectric constant, the temperature behavior is also crucial for a ceramic multilayer capacitor, with a base body constructed as a multilayer capacitor comprising dielectric layers that can be selected from the COG, X7R, Z5U and Y5V temperature classes. Additionally or alternatively, the component can also contain ceramic layers from other temperature classes.

A component constructed as a multilayer varistor may have ceramic layers of bismuth-doped zinc oxide (ZnO—Bi) or praseodymium-doped zinc oxide (ZnO—Pr).

The ceramic base body can also comprise an LTCC or HTCC ceramic. If individual layers of this ceramic are selected from the materials suitable for capacitors, varistors or thermistors, the component functions as two-layer or multilayer component of the capacitor, thermistor, varistor or ferrite component can also be implemented in the LTCC ceramic.

The ceramic base body can also be the substrate of a module, however, wherein several active or passive components are arranged on the upper side of the base body and are electrically connected to component structures arranged in the interior of the base body, wherein the component structures in the interior are formed as additional passive components and/or circuitry structures. The module or the module substrate can also be soldered onto a PCB circuit board with the aid of solder contacts arranged on the underside, with the advantages of the configuration of solder contact and plated through-hole designs proving themselves here as well and helping to provide the module with an improved durability and thus a longer service life.

Described below are embodiments and associated figures. The figures serve solely for improved comprehension and are therefore presented only schematically and not to scale. Size relationships may also be distorted in the reproduction and do not permit any conclusions relating to actual relative dimensions.

### DESCRIPTION OF THE DRAWINGS

FIG. 1 shows a section of a component in a schematic cross section.

FIGS. 2-5 show various embodiments of plated through-holes on the basis of schematic cross sections.

FIG. 6 shows the structure of a solder contact in schematic cross section.

FIGS. 7-9 show various embodiments of electrical components in schematic cross section.

FIG. 10 shows a section of a component soldered to circuit board in schematic cross section.

FIG. 11 shows sections of a component with a passivation.

FIG. 12 shows a section of a component with additional contact surface underneath the passivation and solder contact.

FIG. 13 shows a section of a component with additional contact surface underneath the passivation and non-centered solder contact.

FIG. 14 shows a section of a component with passivation and the surface of the plated through-hole as solder contact.

### DETAILED DESCRIPTION

FIG. 1 shows a section of a multilayer component in a schematic cross section. Two dielectric layers DS1, DS2 are shown, between which is arranged a metallization plane, of which only a circuit conductor section LA is shown in the figure. Not shown are an arbitrary given number of additional dielectric layers and additional metallization planes structured into component structures, which continue the illustrated base body “upwards.” A solder contact LK, which is connected via a plated through-hole DK1 to a metallization plane, here circuit conductor section LA, is arranged on the underside US of the base body. Plated through-hole DK1 has a cross section that broadens towards the top at least in some parts, here over the entire height h_{DS1} of the lowest dielectric layer DS1. Of the additional plated through-holes that are present, which connect additional metallization planes or the component structures contained therein to one another, only one additional plated through-hole DK2 is drawn in here. The additional plated through-hole can be formed with conventional vertical side walls as shown here, but they can also be designed, like plated through-hole DK1 leading to solder contact LK, with a cross section broadening upwards. Otherwise, the manufacturing methods and materials selections known for conventional plated through-holes apply for these plated through-holes, also referred to as vias. The manufacturing of the plated through-hole will be discussed later.

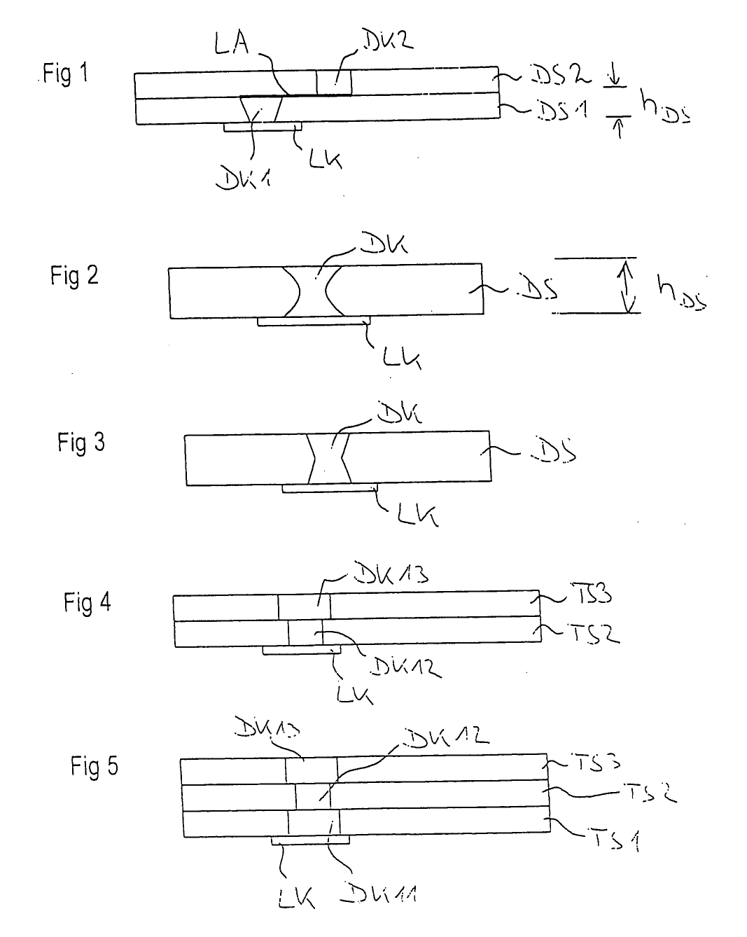

FIG. 2 shows, in schematic cross section, an additional configuration of a plated through-hole DK1 in a dielectric layer DS. This plated through-hole has its smallest cross section in its center area and has concave outer sides. In other words, dielectric layer DS has sides that are rounded in cross section towards through-hole.

FIG. 3 shows another possible shaping of the plated through-hole DK1 through a dielectric layer DS. Here too, a section in the center relative to the height hDS of the dielectric layer has the smallest cross section. Starting from this section, the cross section increases linearly in both directions—in the direction of solder contact LK, and in the opposite direction. A cross section is obtained that has the shape of a double cone colliding at the vertices.

Plated through-holes can be produced with appropriately shaped tools, for instance, rotating ones, in the provided form in a green ceramic film and subsequently metallized or filled with a metallic mass. It is also possible to produce the plated through-hole with material-removing machining oriented nonvertically with respect to the green film.

An elegant method for producing plated through-holes that are formed, for instance, according to FIG. 2 includes carefully controlled manufacturing of the multilayer base body. With a suitable temperature control at a suitable pressure and with a suitable metallization inside the plated through-hole, it is possible to narrow the plated through-hole in the center during pressing and the subsequent sintering, yielding the desired cross-sectional shape.

In another embodiment, FIG. 4 shows a plated through-hole, which runs through two directly adjacent sublayers TS2, TS3. The plated through-hole is distinguished here by the different cross-sectional area or diameter through the individual sublayers. Lower plated through-hole DK12 through sublayer TS2 has a smaller diameter than second plated through-hole DK13 through second dielectric sublayer TS3.

As a variation of the embodiment according to FIG. 4, a plated through-hole can also be passed through three (or more) dielectric sublayers TS1-TS3, with plated through-hole DK12 through middle dielectric sublayer TS2 having the smallest diameter. Plated through-hole DK13 through third sublayer TS3 and plated through-hole DK11 through first sublayer TS1 have larger diameters than plated through-hole DK12.

The embodiments according to FIGS. 4 and 5 have the advantage that they can be produced without great expense with conventional devices and methods for producing multilayer components, since partial plated through-holes DK11 and DK12 can be passed through sublayers TS in the conventional manner with vertical side walls.

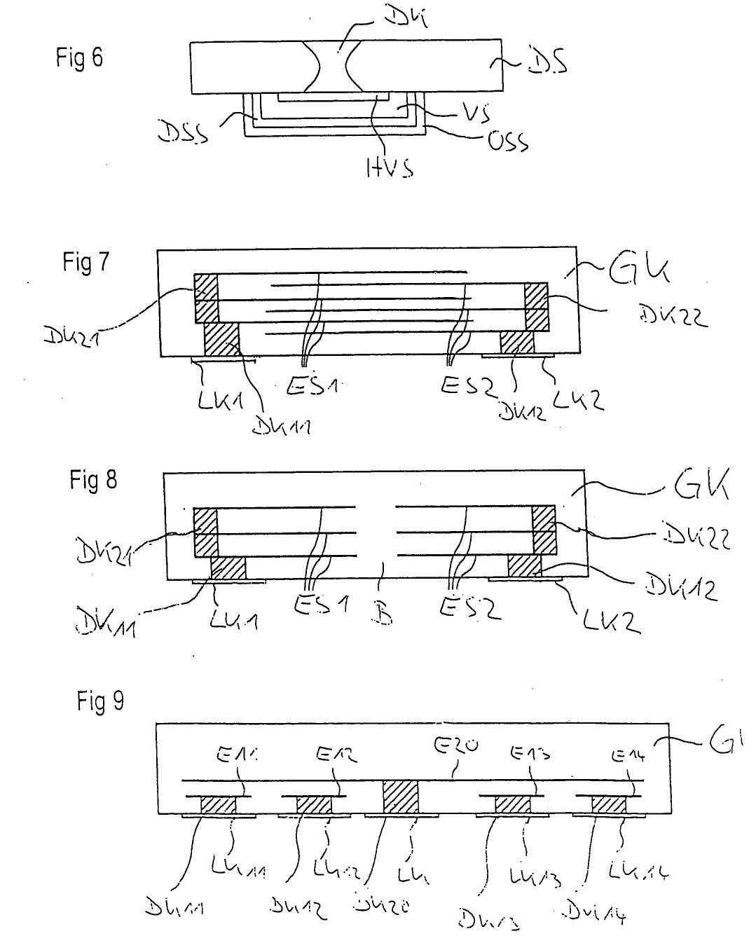

FIG. 6 shows, on the basis of a schematic cross section, the possible structure of a solder contact LK. The solder contact is seated on the underside of the lowest dielectric layer DS, and may be arranged concentrically relative to plated through-hole DK1. Directly on the plated through-hole and lying outside on the ceramic is an adhesion-promoting layer HVS having, for instance, a glass component, or comprising one of the metals nickel, copper, chromium or silver for improving adhesion. This adhesion-promoting layer HVS is reinforced with a reinforcement layer VS, which provides the actual metallic base of the solder contact. Another layer arranged on top of it is a diffusion-blocking layer DSS, which is in turn covered by an antioxidation layer OSS. While the lowest, adhesion-promoting layer HVS of solder contact LK can be printed or sputtered, the following layers, or those placed above it, can be applied by galvanic reinforcement of the adhesion-promoting layer, or can likewise be applied by sputtering. While the galvanic reinforcement of adhesion-promoting layer HVS is self-adjusting, since metal deposition takes place only on the existing metallic layer, the production by sputtering is defined by, for instance, a mask.

FIG. 7 shows further details of one possible design of the component structures in the interior of base body GK. A ceramic capacitor is shown, which has a first stack of electrode layers ES1. Electrode layers of a second stack ES2 are arranged alternating with electrode layers ES1 such that an overlap surface that is as close as possible to a maximum results. At least one electrode ES of each electrode stack is connected via a plated through-hole DK11, DK12 to a solder contact LK1, LK2 of its own on the underside of base body GK. The electrode layers ES belonging to one electrode stack can likewise be connected to one another by plated through-holes DK21, DK22, which are arranged offset to plated through-holes DK1 in the figure. It is also possible, however, for the plated through-holes for connecting the electrode layers ES of a stack and the plated through-hole for connecting the stack to the corresponding solder contact LK to be centered one above the other, or concentric. Plated through-hole DK12 in FIG. 7, for instance, is passed through two dielectric layers, wherein the cross-sectional shape of the plated through-holes through the individual layers can each have the design, as is shown, for example, for plated through-hole DK11 in FIG. 7.

FIG. 8 shows a configuration of a component configured as a varistor, in which two stacks of electrode layers ES1, ES2 are likewise provided in base body GK, wherein the electrode layers of different stacks do not overlap, however. An area B between the stacks therefore has no electrodes. The varistor voltage is determined as a function of the distance between the electrode layers and of the ceramic that is used. It is also possible, however, to construct a multilayer component such as a capacitor or a thermistor with an electrode arrangement as in FIG. 8. In this case, the ceramic material and the distance between the electrode stacks determines the component's resistance or capacitance.

FIG. 9 shows in cross section an additional embodiment of a multilayer component, in which electrodes E11-E14, not overlapping one another, are overlapped by a single electrode E20 with a larger surface area. Each electrode layer E11-E14 is connected by its own plated through-hole DK11-DK14 to a solder contact LK11-LK14 of its own. Electrode layer E20 is connected to a solder contact LK20 via a plated through-hole DK20. Depending on the position of the electrode layer to be contacted, the plated through-hole can be passed through more than one dielectric layer.

For the sake of simplicity, the plated through-holes are shown with straight lines in FIGS. 7-9, but in reality they have cross-sectional shapes with a cross section that widens away from the solder contact.

While only two solder contacts per component were illustrated in FIGS. 7-9, a component is not limited to this number. It is possible, for instance, for component structures or electrode layers ES, circuit conductor sections LA or other parts of metallization planes to be connected via several plated through-holes DK to several solder contacts as well if desired, in order to decrease the corresponding connector resistance or to bridge the surface resistance of electrode layers, circuit conductor section or component structures in the interior of base body GK. It is also possible to produce components that are more than bipolar, which have several terminals of different polarity, or to which a corresponding number of signals with different potential can be applied. This is particularly the case for components that have complex circuitry structures in the interior, or have several stacks of electrode layers that can be individually addressed via the corresponding plated through-holes and solder contacts, or can be electrically connected via these elements.

FIG. 11 shows a section of a component with a passivation P, which is applied here over solder contact LK. An opening in the passivation exposes the surface area of the solder contact at which the bump will be placed.

FIG. 12 shows a further modification of the component described in FIG. 11. An additional contact surface KF is arranged under the passivation. Solder contact LK above passivation P is in contact in opening OE with the contact surface and also with the plated through-hole.

FIG. 13 shows a section of a further modification of the component described in FIG. 12 with the difference that solder contact LK here is not centered above plated through-hole DK. The passivation can be a glass layer, for example.

FIG. 14 shows a section of a component with a passivation P. An opening OE in the passivation exposes the surface area of the plated through-hole, which then can be used directly for the solder contact.

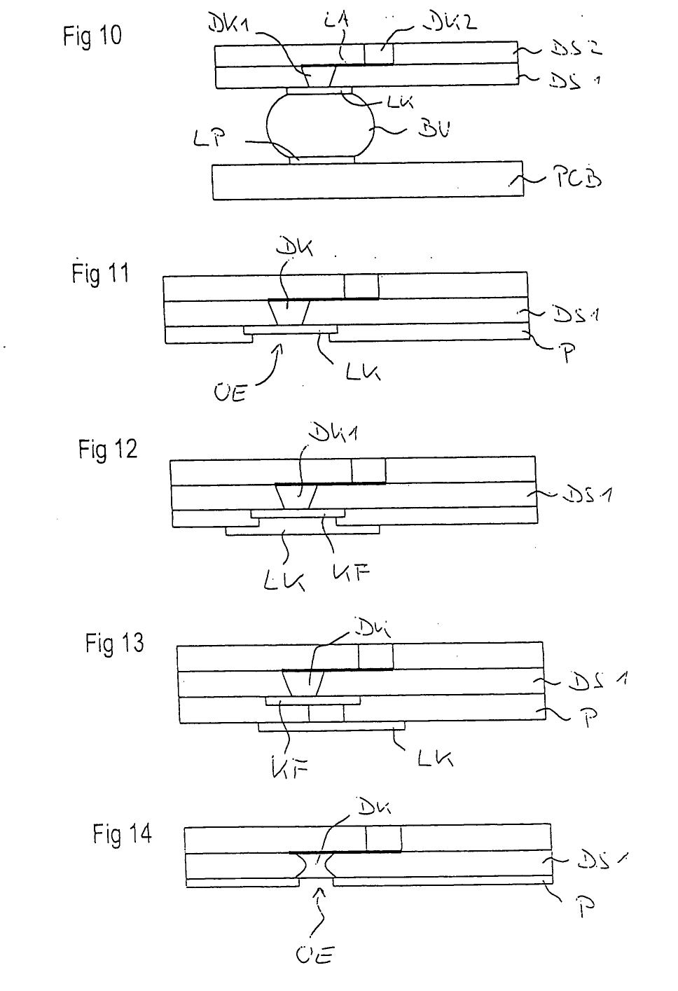

On the basis of a single soldering point, FIG. 10 shows a section of the connection of a multilayer component to a circuit board PCB by a solder ball or bump BU. The solder connection between solder contact LK on the underside of base body GK and a solder pad LP on the upper side of circuit board PCB is effected by bump BU. In the soldered state, the bump wets the entire surface of the corresponding solder contacts LK and LP, so that the surface of these contacts or pads determines the height of the bump for a given volume, and thus the distance above circuit board PCB, at which base body GK or the multilayer component is mounted.

The solder joint shown in FIG. 10 is also referred to as a flip-chip arrangement. In this case, a plurality of bumps BU can effect the electrical and mechanical connection of all solder contacts LK on the underside of the component to the corresponding pads on the upper side of the circuit board. The circuit board here can be constructed as a ball grid array or land grid array.

Although the component was presented only on the basis of a few sample embodiments, it is not limited thereto. In particular, this disclosure covers any designs of component structures that can be implemented in metallization planes between dielectric layers. Such component structures can include passive components that are connected to one another, or complex circuitry structures that include passive components such as resistors, capacitors or inductors that are formed in the base body.

The same ceramic materials may be used for the base body or the dielectric layers. It is also possible, however, to form different dielectric layers inside the base body. Parts of the dielectric layers can therefore also include non-ceramic materials such as plastics.

In an advantageous and likewise not illustrated embodiment, the ceramic is matched with regard to its coefficient of thermal expansion to the material of circuit board PCB, which additionally reduces the thermal strains of the entire component. For example, there is a difference of only 5.6 ppm in their coefficients of thermal expansion between a dielectric layer comprising ZnO and a circuit board made of FR4 materials. A combination of materials selected in this way, with differences between 5 and 7 ppm, has substantially improved durability in comparison to known material combinations, which have differences of 9-11 in coefficients of thermal expansion.

The component is also not limited to the illustrated number of dielectric layers or of electrode layers with component structures that are arranged between them, and can be realized for two or more dielectric layers. Also not shown is the embodiment in which the base body serves only as a carrier substrate for a module whose components are realized on or in the module substrate.

What is claimed is:

1. Electrical multilayer component
with a base body (GK) comprising ceramic dielectric layers (DS) stacked one above the other,
with metallization planes that are structured into component structures (LA, ES) between the dielectric layers,
with solder contacts (LK) on the underside (US) of the base body,
with plated through-holes (DK) that connect the component structures to the solder contacts,
in which the plated through-holes have at least one section in which their cross section widens upward away from the solder contact.

2. Component according to claim 1, in which the cross section of plated through-holes (DK) is smallest in the interior of dielectric layer (DS) and widens upwards and downwards.

3. Component according to claim 1 or 2, in which the edges of corresponding dielectric layer (DS) bounding plated through-holes (DK) are rounded off in cross section.

4. Component according to claim 1 or 2, in which plated through-holes (DK) are approximated in cross section to a double cone colliding at the vertices.

5. Component according to one of claims 1-4, in which additional plated through-holes (DK) are provided, which connect component structures (LA, ES) of different metallization planes to one another, wherein all plated through-holes are formed with the same cross-sectional shape.

6. Component according to one of claims 1-5, in which solder contacts (LK) formed on the underside (US) of base body (GK) overlap the plated through-holes (DK) terminating there and have a glass-containing layer (HVS) on the boundary surface with the base body.

7. Component according to one of claims 1-6, in which solder contacts (LK) comprise a material that is selected from Sn, SnPb, SnAgCu, SnAgCuBi, SnZn and SnAg.

8. Component according to one of claims 1-7. in which a diffusion-blocking layer (DSS) is provided between plated through-hole (DK) and solder contact (LK).

9. Component according to claim 8, in which diffusion-blocking layer (DSS) is selected from Ni and Au.

10. Component according to one of claims 1-9, in which solder contacts (LK) have an antioxidation layer (OSS) as their outermost layer.

11. Component according to claim 10, in which antioxidation layer (OSS) is selected from Au, Sn and an organic layer.

12. Component according to one of claims 1-11, in which plated through-holes (DK) comprise at least one material that is selected from Ag, Pd, Pt, AgPd, AgPt, AgPdPt, Ni, Cu and Au.

13. Component according to one of claims 1-12, in which the lowest layer of solder contacts (LK) in contact with base body (GK) is an adhesion-promoting layer (HVS) that is selected from Ni, Cu, Cr and Ag.

14. Component according to one of claims 1-13, constructed as a multilayer varistor, ceramic multilayer capacitor, thermistor or as a multilayer component comprising a ferrite ceramic.

15. Component according to claim 14, constructed as a ceramic multilayer capacitor wherein the material for ceramic base body (GK) is selected from temperature classes COG, X7R, Z5U and Y5V.

16. Component according to claim 14, constructed as a ceramic multilayer varistor wherein the material for ceramic base body (GK) comprises ZnO—Bi or ZnO—Pr.

17. Component according to one of claims 1-16, in which ceramic base body (GK) is an LTCC or an HTCC ceramic.

18. Component according to one of claims 1-17, in which ceramic base body (GK) is constructed as a substrate for a module, wherein several active or passive components are formed on the upper side of the base body and are electrically connected to the component structures in the interior of the base body, wherein said component structures are constructed as additional passive components and circuitry structures.

19. Component according to one of claims 1-18, in which plated through-holes (DK) in contact with solder contacts (LK) are passed with different diameters through at least two dielectric sublayers (TS1, TS2), wherein the diameter of the plated through-holes in sublayer (TS3) further removed from the solder contact is larger than that in a sublayer (TS2) situated closer to the solder contact.

20. Component according to one of claims 1-19, in which a passivation (P) for ceramic dielectric layers (DS) is arranged on base body (GK).

21. Component according to claim 20, in which, directly above each of plated through-holes (DK), a contact surface (KF) of larger surface area is provided, wherein passivation (P) is arranged over the contact surface, and solder contact (LK) is arranged on the passivation, wherein the solder contact is electrically connected to the contact surface via openings (OE) in the passivation.
